(19) United States
(12) Patent Application Publication
(10) Pub. No.: US 2010/0229144 A1
(43) Pub. Date: Sep. 9, 2010

(54) SYSTEM AND METHOD FOR BEHAVIORAL SYNTHESIS

(75) Inventor: Takahide EZAKI, Kanagawa (JP)

Correspondence Address: YOUNG & THOMPSON, 209 Madison Street, Suite 500, Alexandria, VA, 22314, US

(73) Assignee: NEC ELECTRONICS CORPORATION, Kanagawa (JP)

(21) Appl. No.: 12/717,377

(22) Filed: Mar. 4, 2010

(30) Foreign Application Priority Data
Mar. 4, 2009 (JP) 2009-051291

(51) Int. Cl. G06F 17/50

(52) U.S. Cl. 716/18

(57) ABSTRACT

An operation synthesis system includes an operation synthesizing section configured to perform operation synthesis of an operation description to generate a data path graph corresponding to the operation description, wherein the data path graph contains an input terminal configured to input an input data and an operating unit configured to perform an operation on the input data; and a gating circuit inserting section configured to insert a gating circuit between the input terminal and the operating unit. The gating circuit blocks off transmission of the input data from the input terminal to the operating unit when the operating unit does not need the input data, and transmits the input data from the input terminal to the operating unit only when the operating unit needs the input data.

### INCORPORATION BY REFERENCE

This application claims a priority on convention based on Japanese Patent Application No. 2009-051291. The disclosure thereof is incorporated herein by reference.

### TECHNICAL FIELD

The present invention relates to a behavioral synthesis technique for generating an RTL description from a behavioral description.

### BACKGROUND ART

“Behavioral synthesis” for generating RTL (Register Transfer Level) description from behavioral description is known. In the behavioral description, algorithm to be realized in a design circuit is described in the C language and the like. The RTL description obtained by the behavioral synthesis is inputted to logic synthesis.

Patent literature 1 describes behavioral synthesis processing when one operating unit is shared by a plurality of operation processes, that is, when an output of the operating unit is supplied to a plurality of operating units subsequent to the above operating unit. In such a case, a problem arises that an excessive power consumption amount occurs in non-active subsequent operating units. Thus, an input fixing unit is inserted between the one operating unit and the subsequent operating units. When the succeeding operating units are in a non-active state, the fixing unit sets an input to the subsequent operating units to a fixed state.

When transition of an input data supplied to an input terminal of a circuit unnecessarily propagates to an operating unit in the circuit, electric power is wastefully consumed. Therefore, it is desirable to reduce such a useless power consumption amount in a phase of behavioral synthesis.

### CITATION LIST

Patent Literature
Patent literature 1: JP 2007-213265A

### SUMMARY OF THE INVENTION

In an aspect of the present invention, an operation synthesis system includes: an operation synthesizing section configured to perform operation synthesis of an operation description to generate a data path graph corresponding to the operation description, wherein the data path graph contains an input terminal configured to input an input data and an operating unit configured to perform an operation on the input data; and a gating circuit inserting section configured to insert a gating circuit between the input terminal and the operating unit. The gating circuit blocks off transmission of the input data from the input terminal to the operating unit when the operating unit does not need the input data, and transmits the input data from the input terminal to the operating unit only when the operating unit needs the input data.

In another aspect of the present invention, an operation synthesis method is achieved by performing operation synthesis of an operation description to generate a data path graph corresponding to the operation description, wherein the data path graph contains an input terminal configured to input an input data and an operating unit configured to perform an operation on the input data; and by inserting a gating circuit between the input terminal and the operating unit. The gating circuit blocks off transmission of the input data from the input terminal to the operating unit when the operating unit does not need the input data, and transmits the input data from the input terminal to the operating unit only when the operating unit needs the input data.

In still another aspect of the present invention, a computer-readable recording medium in which a program code is stored to realize an operation synthesis method, which is achieved by performing operation synthesis of an operation description to generate a data path graph corresponding to the operation description, wherein the data path graph contains an input terminal configured to input an input data and an operating unit configured to perform an operation on the input data; and by inserting a gating circuit between the input terminal and the operating unit. The gating circuit blocks off transmission of the input data from the input terminal to the operating unit when the operating unit does not need the input data, and transmits the input data from the input terminal to the operating unit only when the operating unit needs the input data.

According to the behavioral synthesis technique of the present invention, a power consumption amount of the circuit to be designed can be reduced.

### BRIEF DESCRIPTION OF THE DRAWINGS

The above and other objects, advantages and features of the present invention will be more apparent from the following description of certain embodiments taken in conjunction with the accompanying drawings, in which:

FIG. 1 shows an example of behavioral description;

FIG. 2 shows CDFG corresponding to the behavioral description shown in FIG. 1;

FIG. 3 shows states/conditions in which functions refer to an input variable;

FIG. 4 shows a data path graph corresponding to CDFG shown in FIG. 2;

FIG. 5 shows a data path graph to which a gating circuit is inserted;

FIG. 6 shows enable signals for activating/deactivating the gating circuit;

FIG. 7 shows an example of a transition of input data;

FIG. 8 shows propagation of the input data transition to a submodule when gating is not performed;

FIG. 9 shows propagation of the input data transition to the submodule when gating is performed;

FIG. 10 shows a relation between data supplied to a submodule f1 and the type of the gating circuit;

FIG. 11 shows a relation between data supplied to a submodule f2 and the type of the gating circuit;

FIG. 12 shows call count data;

FIG. 13 is a block diagram showing a configuration of a behavioral synthesizing system according to an embodiment of the present invention;

FIG. 14 is a functional block diagram showing the behavioral synthesizing system according to the embodiment of the present invention; and

FIG. 15 is a flow chart showing behavioral synthesis processing according to the embodiment of the present invention.

### DESCRIPTION OF EMBODIMENTS

### 1. Behavioral Synthesis

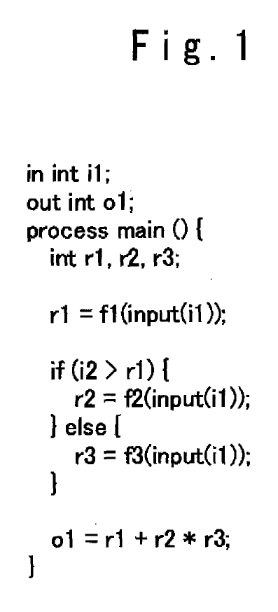

FIG. 1 shows an example of behavioral description. In the behavioral description, “i1” is an input variable, “o1” is an output variable, and “f1”, “f2” and “f3” are functions for performing respective operations.

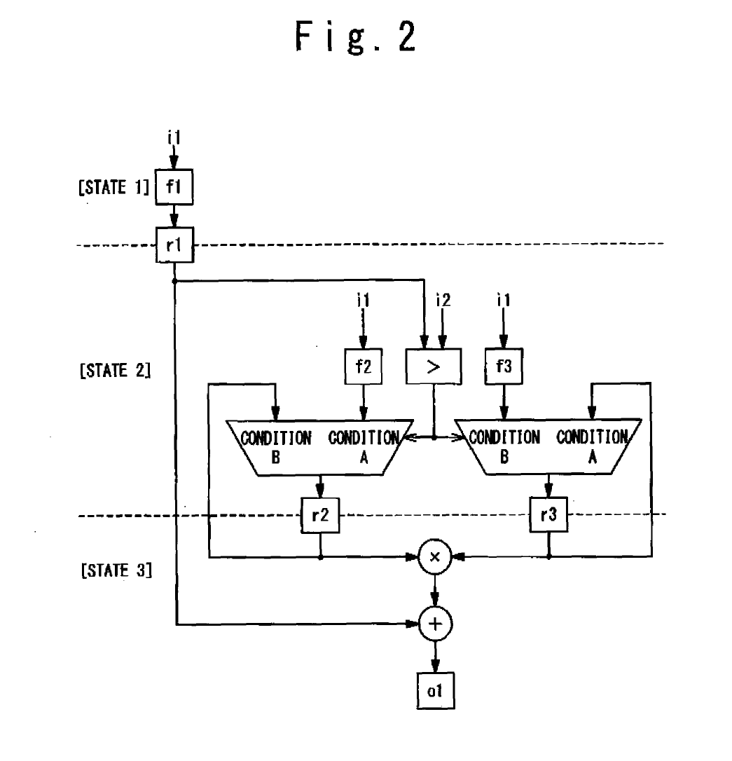

In behavioral synthesis, the behavioral description is first converted into CDFG (Control Data Flow Graph). The CDFG shows data flow in the behavioral description. For example, the behavioral description shown in FIG. 1 is converted into CDFG shown in FIG. 2. A condition A is that “i2>r1” is true, and a condition B is that “i2>r1” is false. Further, scheduling is performed on the basis of CDFG and the number of steps (the number of cycles) for performing an operation is determined. In the example shown in FIG. 2, the operation is achieved in three steps and the three steps are associated with [state 1] to [state 3].

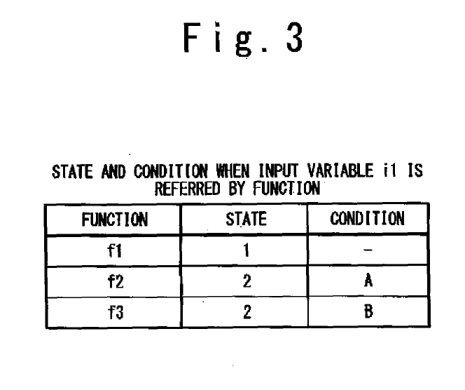

At this time, the states/conditions are obtained in which the functions (f1 to f3) refer to the input variable i1. As shown in FIG. 3, the function f1 refers to the input variable i1 in the [state 1]. The function f2 refers to the input variable i1 in the [state 2] and a [condition A]. The function f3 refers to the input variable i1 in the [state 2] and the [condition B]. Oppositely speaking, in cases other than the states/conditions shown in FIG. 3, each function does not require the input variable i1.

Subsequently, allocation (data path allocation) is performed to allocate a register and an operating unit to the variable and the function (operation). Furthermore, a sequence and a control signal are determined, and as a result of this, a data path graph is generated.

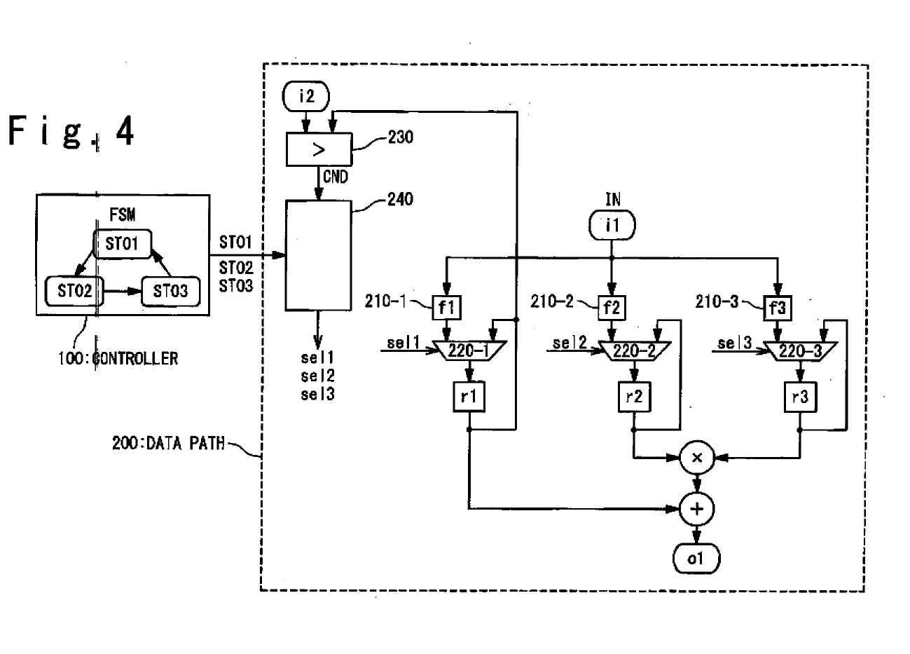

FIG. 4 shows a data path graph corresponding to CDFG shown in FIG. 2. The data path graph includes a data path 200 for executing operation processing of data, and a controller 100 for controlling the data path 200. The controller 100 is also referred to as an FSM (Finite State Machine). The controller 100 generates status signals ST01 to ST03 for designating [state 1] to [state 3], respectively, sequentially and repeatedly. The status signals ST01 to ST03 are sequentially supplied to the data path 200 to control the operation processing in the data path 200.

The data path 200 includes an input terminal IN, submodules 210-1 to 210-3, selectors 220-1 to 220-3, a determination circuit 230 and a control signal generating circuit 240.

A value of the input variable i1 is supplied to the input terminal IN. The value of the input variable i1 is hereinafter referred to as an “input data i1”.

Each submodule (lower module) 210 is an operating unit or a set of operating units for performing a predetermined operation. The submodules 210-1 to 210-3 correspond to the above-mentioned functions f1 to f3, respectively. In other words, the submodules 210-1 to 210-3 perform operations of the functions f1 to f3, respectively, by using the input data i1 inputted to the input terminal IN.

The selectors 220-1 to 220-3 are connected to outputs of the submodules 210-1 to 210-3, respectively. Operations of the selectors 220-1 to 220-3 are controlled by select signals sell to sel3, respectively.

The determination circuit 230 determines a conditional branch “i2>r1” and generates a condition signal CND representing a determination result. When “i2>r1” is true, that is, in the case of the above-mentioned condition “A”, the condition signal CND represents “1”. On the contrary, when “i2>r1” is false, that is, in the case of the above-mentioned condition “B”, a condition signal CND represents “0”.

The control signal generating circuit 240 receives the status signals ST01 to ST03 outputted from the controller 100 and the condition signal CND outputted from the determination circuit 230. Then, the control signal generating circuit 240 generates various control signals (select signals sell to sel3) on the basis of the status signals ST01 to ST03 and the condition signal CND.

In the data path 200 shown in FIG. 4, when the input data i1 transits, the transition of the input data i1 always propagates to all of the submodules 210-1 to 210-3. However, as mentioned above, in the cases other than the states/conditions shown in FIG. 3, each submodule 210 does not require the input data i1. When the transition of the input data i1 unnecessarily propagates to each submodule 210, electric power is uselessly consumed.

In the present embodiment, as described below, a gating circuit is inserted into the data path 200 in the stage of behavioral synthesis. Thereby, unnecessary propagation of the transition of the input data i1 is suppressed, reducing useless power consumption.

### 2. Insertion of Gating Circuit

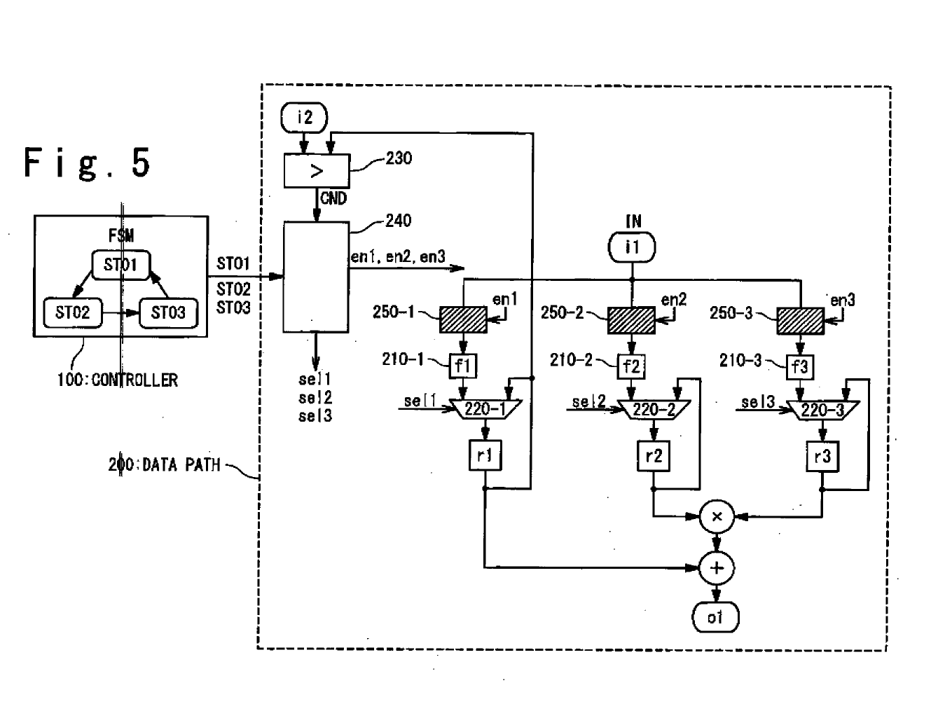

In the present embodiment, gating circuits 250 are inserted between the input terminal IN and the submodule 210 in the data path 200. Only when the “states/conditions” shown in FIG. 3 are satisfied, the gating circuits 250 transmit the input data i1 supplied to the input terminal IN to the submodules 210. FIG. 5 shows the data path graph to which the gating circuits 250 are inserted.

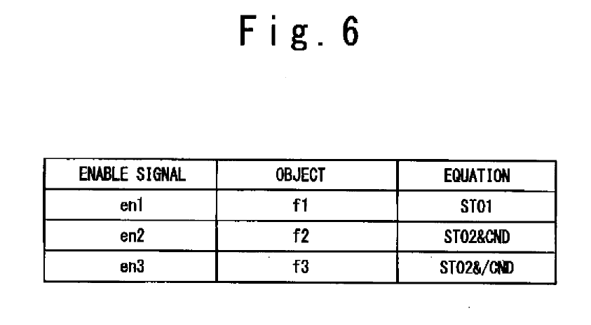

The gating circuit 250-1 is inserted between the input terminal IN and the submodule 210-1. In other words, an input of the gating circuit 250-1 is connected to the input terminal IN and an output of the gating circuit 250-1 is connected to the submodule 210-1. When the submodule 210-1 does not require the input data i1, the gating circuit 250-1 blocks off transmission of the input data i1 from the input terminal IN to the submodule 210-1. Only when the submodule 210-1 requires the input data i1, the gating circuit 250-1 transmits the input data i1 from the input terminal IN to the submodule 210-1. Describing in more detail, an enable signal en1 shown in a formula in FIG. 6 is supplied to the gating circuit 250-1. The enable signal en1 is generated by the control signal generating circuit 240 on the basis of the status signal ST01. In the [state 1: ST01], that is, when the submodule 210-1 (the function f1) requires the input data i1, the enable signal en1 is activated (en1=“1”), and in the other cases, the enable signal en1 is deactivated (en1=“0”). When the enable signal en1 is activated (en1=“1”), the gating circuit 250-1 transmits the input data i1 from the input terminal IN to the submodule 210-1. On the contrary, when the enable signal en1 is deactivated (en1=“0”), the gating circuit 250-1 blocks off transmission of the input data i1 from the input terminal IN to the submodule 210-1.

The gating circuit 250-2 is inserted between the input terminal IN and the submodule 210-2. In other words, an input of the gating circuit 250-2 is connected to the input terminal IN and an output of the gating circuit 250-2 is connected to the submodule 210-2. When the submodule 210-2 does not require the input data i1, the gating circuit 250-2 blocks off transmission of the input data i1 from the input terminal IN to the submodule 210-2. Only when the submodule 210-2 requires the input data i1, the gating circuit 250-2 transmits the input data i1 from the input terminal IN to the submodule 210-2. Describing in more detail, an enable signal en2 shown in a formula in FIG. 6 is supplied to the gating circuit 250-2. The enable signal en2 is generated by the control signal generating circuit 240 on the basis of the status signal ST02 and the condition signal CND. In the [state 2: ST02] and the [condition A: CND=1], that is, only when the submodule 210-2 (the function f2) requires the input data i1, the enable signal en2 is activated (en2=“1”) and in the other cases, the enable signal en2 is deactivated (en2=“0”). When the enable signal en2 is activated (en2=“1”), the gating circuit 250-2 transmits the input data i1 from the input terminal IN to the submodule 210-2. On the contrary, when the enable signal en2 is deactivated (en2=“0”), the gating circuit 250-2 blocks off transmission of the input data i1 from the input terminal IN to the submodule 210-2.

The gating circuit 250-3 is inserted between the input terminal IN and the submodule 210-3. In other words, an input of the gating circuit 250-3 is connected to the input terminal IN and an output of the gating circuit 250-3 is connected to the submodule 210-3. When the submodule 210-3 does not require the input data i1, the gating circuit 250-3 blocks off transmission of the input data i1 from the input terminal IN to the submodule 210-3. Only when the submodule 210-3 requires the input data i1, the gating circuit 250-3 transmits the input data i1 from the input terminal IN to the submodule 210-3. Describing in more detail, an enable signal en3 shown in a formula in FIG. 6 is supplied to the gating circuit 250-3. The enable signal en3 is generated by the control signal generating circuit 240 on the basis of the status signal ST02 and the condition signal CND. In the [state 2: ST02] and the [condition B: CND=0], that is, only when the submodule 210-3 (the function f3) requires the input data i1, the enable signal en3 is activated (en3=“1”) and in the other cases, the enable signal en3 is deactivated (en3=“0”). When the enable signal en3 is activated (en3=“1”), the gating circuit 250-3 transmits the input data i1 from the input terminal IN to the submodule 210-3. On the contrary, when the enable signal en3 is deactivated (en3=“0”), the gating circuit 250-3 blocks off transmission of the input data i1 from the input terminal IN to the submodule 210-3.

By inserting the gating circuits 250 in this manner, transition of the input data i1 can be prevented from unnecessarily propagating to the submodules 210. As a result, the power consumption amount of the circuit to be designed is reduced.

### 3. Types of Gating Circuit

The gating circuit 250 is broadly classified into two types: “LATCH” type and “AND” type.

When the enable signal en is activated, the LATCH type gating circuit 250 outputs the input data i1 supplied to the input terminal IN to the submodule 210. In this case, when the input data i1 transits, the transition of the input data i1 propagates to the submodule 210. On the contrary, when the enable signal en is deactivated, the LATCH type gating circuit 250 latches the input data i1 at this time and outputs the latched data. In other words, the output of the Latch type gating circuit 250 to the submodule 210 is kept as a value at the time when the enable signal en is deactivated. In this case, even when the input data i1 supplied to the input terminal IN transits, the transition of the input data i1 does not propagate to the submodule 210. The LATCH type gating circuit 250 includes, but not limited to, a latch circuit.

When the enable signal en is activated, the AND type gating circuit 250 outputs the input data i1 supplied to the input terminal IN to the submodule 210. In this case, when the input data i1 transits, the transition of the input data i1 propagates to the submodule 210. On the contrary, when the enable signal en is deactivated, the AND type gating circuit 250 fixes the output to the submodule 210 to a predetermined value. For example, when the gating circuit 250 is an AND gate, if the enable signal en is deactivated (en=0), the output is fixed to “0”. In this case, even when the input data i1 supplied to the input terminal IN transits, the transition of the input data i1 does not propagate to the submodule 210. The AND type gating circuit 250 includes, but not limited to, the AND gate. Any logical circuit, an output of which is fixed to a predetermined value in response to deactivation of the enable signal en, may be employed.

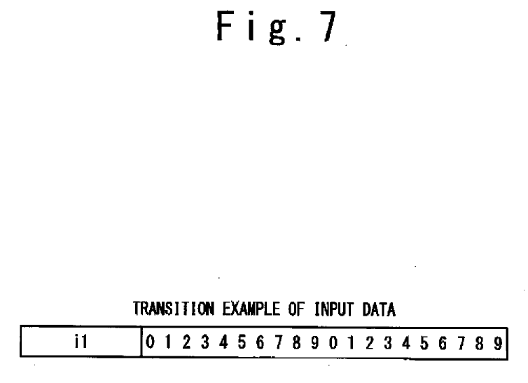

Gating effects in using the LATCH type and the AND type each will be described below. As an example, the transition of the input data (input variable) i1 is assumed, as shown in FIG. 7. It is assumed that, as shown in FIG. 7, 20 input data i1 are sequentially supplied to the input terminal IN.

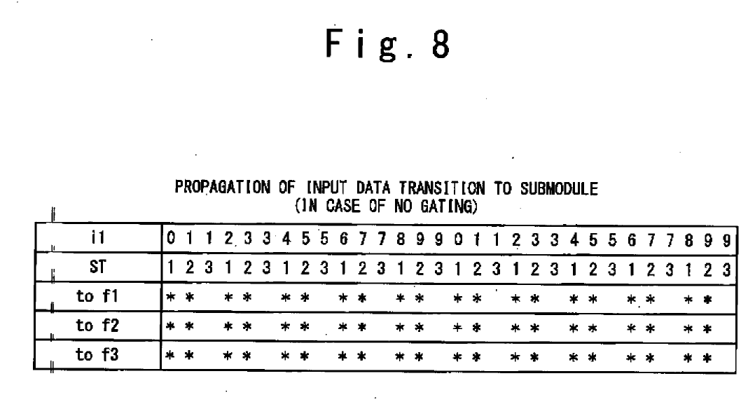

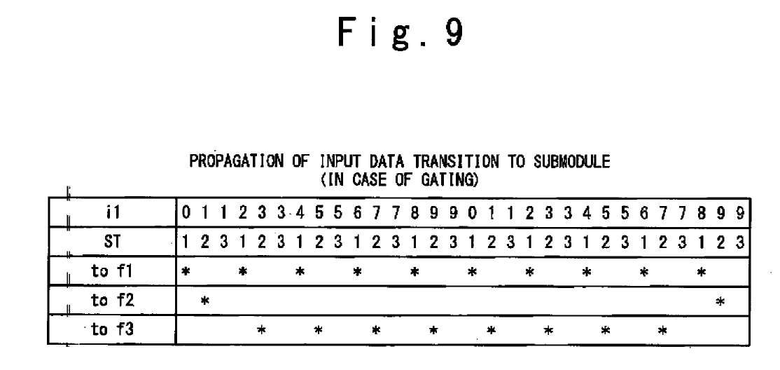

FIGS. 8 and 9 show propagation of the transition of the input data i1 to each submodule 210. FIG. 8 shows a case where gating is not performed (refer to FIG. 4) and FIG. 9 shows a case where gating is performed (refer to FIG. 5). FIGS. 8 and 9 show transition of the input data i1 and the status signals ST to the submodule 210-1 (f1), the submodule 210-2 (f2) and the submodule 210-3 (f3). A “*” mark in the figures represents that the transition of the input data i1 propagates to the respective submodules 210.

As shown in FIG. 8, when gating is not performed, the transition of the input data i1 always propagates to all of the submodules 210-1 to 210-3. On the contrary, when the gating is performed as in the present embodiment, only when each submodule 210 requires the input data i1, the transition of the input data i1 propagates to the respective submodule 210. In other words, only when each function (f1 to f3) is called and refers to the input data i1, the transition of the input data i1 propagates to the corresponding submodule 210. The number of times of call of each function (f1 to f3) (hereinafter to be referred to as a “call count”) is the same as the number of times of the operation by the corresponding submodule 210 by using the input data i1. In an example shown in FIG. 9, the call counts of the functions f1, f2, f3 are 10, 2 and 8, respectively.

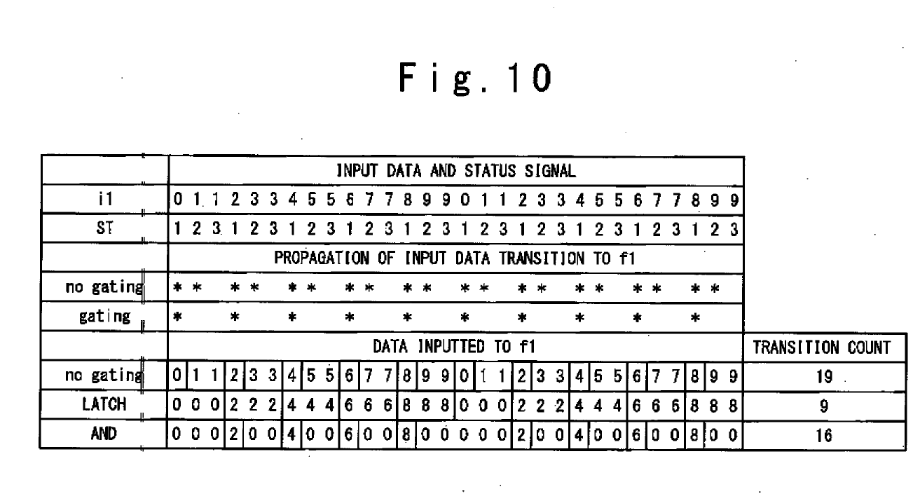

FIG. 10 shows a relation between data supplied to the submodule 210-1 (f1) and the type of the gating circuit 250-1. As described above, the call count of the function f1 corresponding to the submodule 210-1 is 10. As shown in FIG. 10, when gating is not performed, the data supplied to the submodule 210-1 transits (changes) 19 times. When the latch circuit is inserted as the gating circuit 250-1, the data supplied to the submodule 210-1 transits only 9 times. When the AND gate is inserted as the gating circuit 250-1, the data supplied to the submodule 210-1 transits 16 times.

In this manner, the gating effect obtained by using the LATCH type is larger than the gating effect obtained by using the AND type. Especially, in the case of the submodule 210-1 corresponding to the function f1 with relatively large call count, the effect of using the LATCH type is pronounced. By inserting the LATCH type gating circuit 250-1, the transition of the input data i1 can be prevented from propagating and furthermore, the number of times of transition of the data supplied to the submodule 210-1 can be greatly reduced. As a result, a power consumption amount in the submodule 210-1 is greatly reduced.

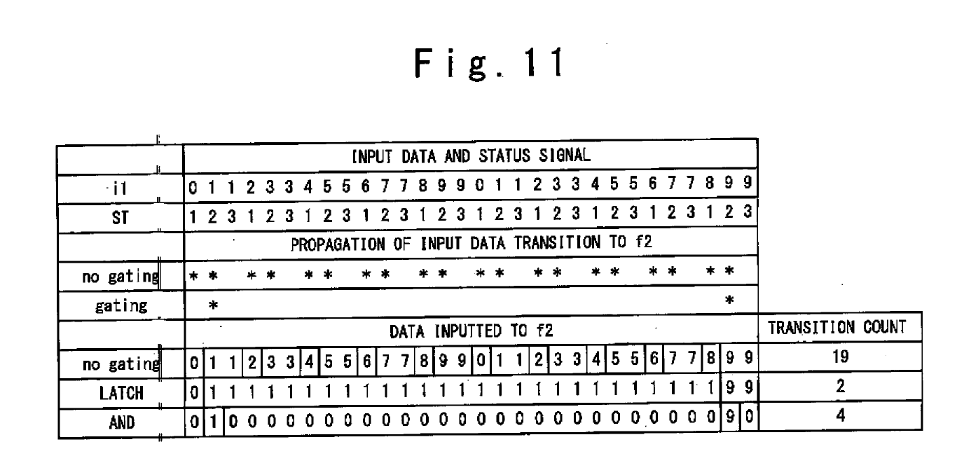

FIG. 11 shows a relation between data supplied to the submodule 210-2 (f2) and the type of the gating circuit 250-2. As described above, the call count of the function f2 corresponding to the submodule 210-2 is 2. When the gating is not performed as shown in FIG. 11, the data supplied to the submodule 210-2 transits (changes) 19 times. When the latch circuit is inserted as the gating circuit 250-2, the data supplied to the submodule 210-2 transits only twice. When the AND gate is inserted as the gating circuit 250-2, the data supplied to the submodule 210-2 transits only 4 times.

In this manner, in the case of the submodule 210-2 corresponding to the function f2 with the small call count, both the LATCH type and AND type achieve a pronounced effect. By inserting the LATCH type or AND type gating circuit 250-2, the transition of the input data i1 can be suppressed from propagating and furthermore, the number of times of transition of the data supplied to the submodule 210-2 can be greatly reduced.

In terms of a circuit area, the AND type is smaller than the LATCH type and thus, is suitable. In other words, the AND type has a feature that the gating effect is relatively small but the circuit area is small. As shown in FIG. 11, in the case of the small call count, even when the AND type gating circuit 250 is used, a sufficient gating effect is obtained. In other words, when the call count is small, both of reduction in a power consumption amount and suppression of increase in the circuit area can be achieved by using the AND type.

In consideration of the above description, it is preferred to determine the type of the gating circuit 250 depending on the call count of the function. When the call count is large, the LATCH type is preferably selected as the gating circuit 250. On the contrary, when the call count is small, the AND type is preferably selected as the gating circuit 250. For example, the call counts (10, 2, 8) of the functions (f1, f2, f3) are compared with a predetermined threshold (ex. 5). When the call count is equal to or larger than the predetermined threshold, the LATCH type is selected as the gating circuit 250. When the call count is less than the predetermined threshold, the AND type is selected as the gating circuit 250.

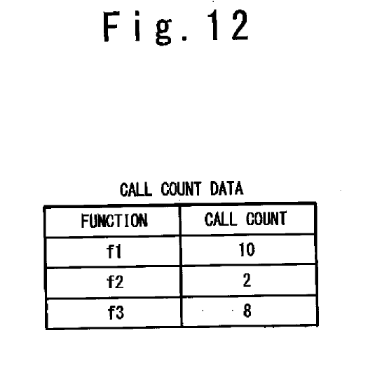

It should be noted that the call count of each function with respect to the transition of the input data i1 can be previously calculated by “behavioral description simulation”. The behavioral description simulation is performed by a well-known behavioral description simulator. The behavioral description in FIG. 1 and the transition of the input data (input variable) i1 in FIG. 7 are supplied to the behavioral description simulator. As a result of the behavioral description simulation, the call count of each function (f1, f2, f3) corresponding to the transition of the input data i1 is calculated. FIG. 12 shows the call count data indicating the calculated call count. In the present embodiment, as described above, the call counts of the functions f1, f2, f3 are 10, 2, and 8, respectively. In the behavioral synthesis, the type of the gating circuit 250 may be determined by referring to the call count data.

### 4. Behavioral Synthesis System

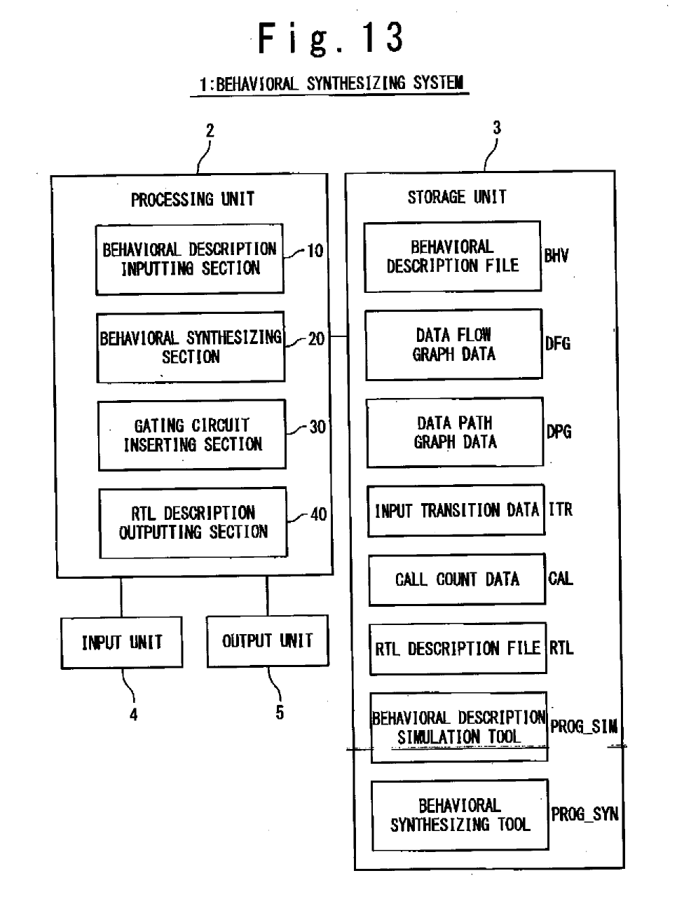

FIG. 13 is a block diagram showing a configuration of a behavioral synthesizing system 1 according to an embodiment of the present invention.

The behavioral synthesizing system 1 in the present embodiment is a computer system for performing the “behavioral synthesis processing”. The behavioral synthesizing system 1 includes a processing unit 2, a storage unit 3, an input unit 4 and an output unit 5. Examples of the storage unit 3 include HDD and RAM. Examples of the input unit 4 include a keyboard and a mouse. Examples of the output unit 5 include a display.

The storage unit 3 stores a behavioral description file BHV, a data flow graph data DFG, a data path graph data DPG, an input transition data ITR, a call count data CAL and an RTL description file RTL therein. The behavioral description file BHV represents the behavioral description shown in FIG. 1. The data flow graph data DFG represents CDFG shown in FIG. 2. The data path graph data DPG represents the data path graph shown in FIGS. 4 and 5. The input transition data ITR represents the transition of the input data (input variable) i1 shown in FIG. 7. The call count data CAL is shown in FIG. 12 and obtained through the behavioral description simulation. The RTL description file RTL represents the RTL description obtained as a result of the behavioral synthesis processing.

The storage unit 3 also stores a behavioral description simulation tool PROG_SIM therein. The behavioral description simulation tool PROG_SIM is a well-known computer program executed by the processing unit 2. Using the behavioral description file BHV and the input transition data ITR, the behavioral description simulation tool PROG_SIM performs the behavioral description simulation and previously prepares the call count data CAL (refer to FIG. 12).

The storage unit 3 also stores a behavioral synthesizing tool (behavioral synthesis program) PROG_SYN therein. The behavioral synthesizing tool PROG_SYN is a computer program executed by the processing unit 2. The behavioral synthesizing tool PROG_SYN may be recorded in and loaded from a computer-readable recording medium. By performing the behavioral synthesizing tool PROG_SYN in the processing unit 2, the behavioral synthesis processing in the present embodiment is realized. Describing in more detail, by performing the behavioral synthesizing tool PROG_SYN in the processing unit 2, as shown in FIG. 13, a behavioral description inputting section 10, a behavioral synthesizing section 20, a gating circuit inserting section 30 and an RTL description outputting section 40 are realized.

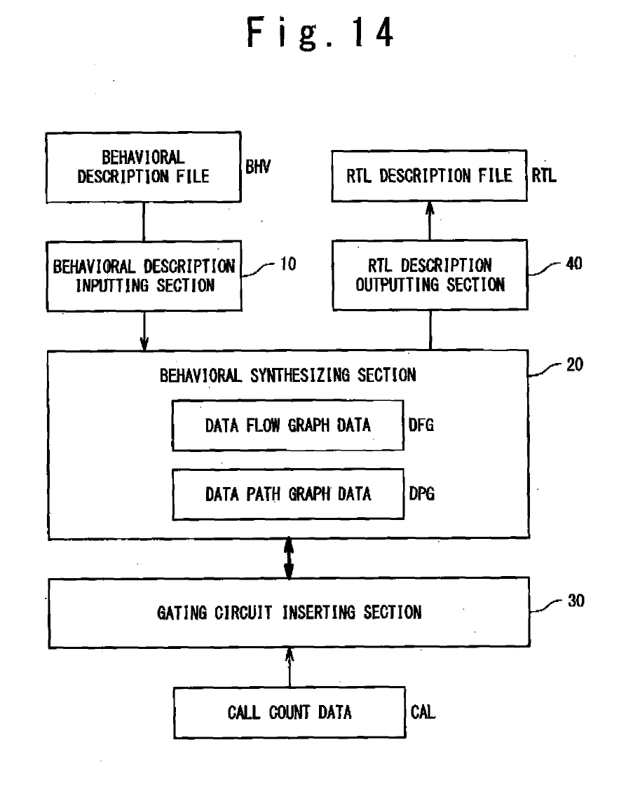

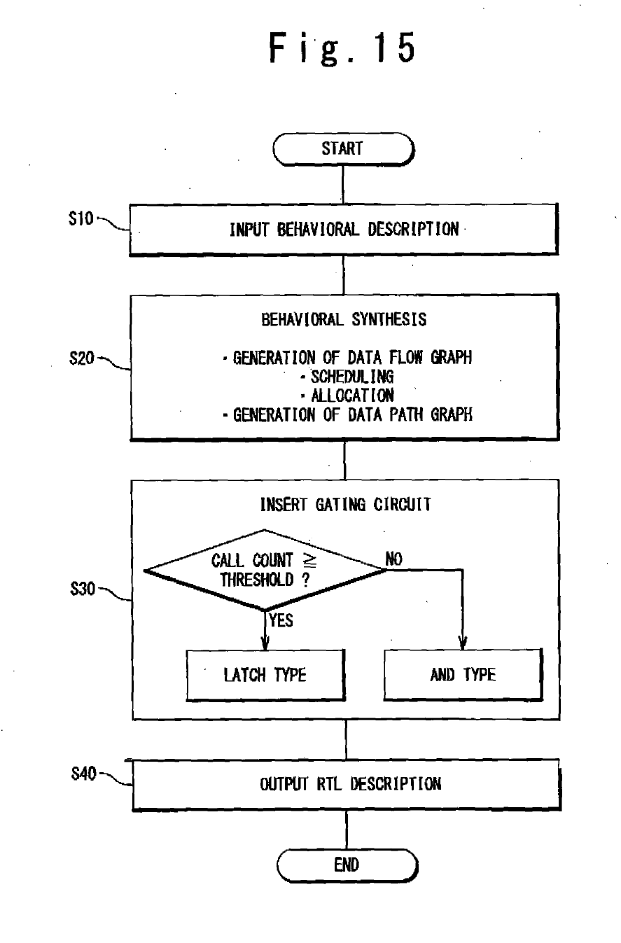

FIG. 14 shows functional blocks of the behavioral synthesizing system 1 in accordance with the present embodiment. As shown in FIG. 14, the behavioral synthesizing system 1 includes the behavioral description inputting section 10, the behavioral synthesizing section 20, the gating circuit inserting section 30 and the RTL description outputting section 40. FIG. 15 is a flow chart of the behavioral synthesis processing in accordance with the present embodiment. Referring to FIGS. 14 and 15, the behavioral synthesis processing by the behavioral synthesizing system 1 in the present embodiment will be described.

### Step S10:

First, the behavioral description inputting section 10 reads the behavioral description file BHV from the storage unit 3. The behavioral description file BHV is supplied to the behavioral synthesizing section 20.

### Step S20:

The behavioral synthesizing section 20 performs the behavioral synthesis (generation of CDFG, scheduling, allocation, etc.) for the behavioral description (refer to FIG. 1) given from the behavioral description file BHV according to an ordinary method. At this time, the total number of operating devices, clock frequency and the number of cycles are given as constraint conditions. As a result of the behavioral synthesis, CDFG corresponding to the behavioral description (refer to FIG. 2) and the data path graph corresponding to the behavioral description (refer to FIG. 4) are generated. The data flow graph data DFG and the data path graph data DPG are stored in the storage unit 3.

### Step S30:

The gating circuit inserting section 30 grasps the states/conditions in which each function refers to the input variable i1 (refer to FIG. 3) on the basis of CDFG represented by the data flow graph data DFG. Further, the gating circuit inserting section 30 inserts the gating circuit 250 so that transmission of the input data i1 is blocked off in the cases other than the states/conditions shown in FIG. 3. Describing in more detail, the gating circuit inserting section 30 inserts the gating circuit 250 between the input terminal IN and the submodule (operating unit) 210 in the data path graph shown in FIG. 4. As a result, the data path graph shown in FIG. 5 is obtained. Here, the gating circuit inserting section 30 sets the enable signals en1 to en3 to the gating circuits 250-1 to 250-3, respectively, as shown in FIG. 6.

Preferably, the type of the gating circuit 250 is determined depending on the call count of each function. For this reason, the gating circuit inserting section 30 reads the call count data CAL (refer to FIG. 12) from the storage unit 3. Then, the gating circuit inserting section 30 compares the call count of each function, which is represented in the call count data CAL, with a predetermined threshold. When the call count is equal to or larger than the predetermined threshold, the gating circuit inserting section 30 selects the LATCH type circuit as the gating circuit 250. When the call count is less than the predetermined threshold, the gating circuit inserting section 30 selects the AND type circuits as the gating circuit 250. Thereby, reduction in a power consumption amount and suppression of increase in the circuit area can be achieved.

As described above, the gating circuit inserting section 30 inserts the gating circuit 250 into the data path graph and updates the data path graph. The data path graph data DPG representing the updated data path graph is stored in the storage unit 3.

For the input variable whose value remains unchanged, gating needs not to be performed. The user may previously designate the input variable whose value remains unchanged. When a transition probability of an input variable is 0%, the behavioral synthesizing system 1 does not perform gating for the input variable.

### Step S40:

The RTL description outputting section 40 reads the updated data path graph data DPG from the storage unit 3. The RTL description outputting section 40 generates RTL description corresponding to the data path graph shown in FIG. 5. Then, the RTL description outputting section 40 stores the RTL description file RTL representing the generated RTL description in the storage unit 3.

Then, logic synthesis is performed on the basis of the RTL description and a net list of a gate level is generated. Furthermore, layout design is performed on the basis of the net list. Subsequently, a designed circuit is manufactured on the basis of layout data. In the manufactured circuit, power consumption amount is reduced.

The embodiments of the present invention have been described referring to the attached drawings. However, the present invention is not limited to the above-mentioned embodiments and may be appropriately modified by those skilled in the art so as not to deviate from the scope and spirit of the present invention.

What is claimed is:

1. An operation synthesis system comprising:
an operation synthesizing section configured to perform operation synthesis of an operation description to generate a data path graph corresponding to the operation description, wherein said data path graph contains an input terminal configured to input an input data and an operating unit configured to perform an operation on the input data; and
a gating circuit inserting section configured to insert a gating circuit between said input terminal and said operating unit,
wherein said gating circuit blocks off transmission of the input data from said input terminal to said operating unit when said operating unit does not need the input data, and transmits the input data from said input terminal to said operating unit only when said operating unit needs the input data.

2. The operation synthesis system according to claim 1, wherein said operation is shown as a function in the operation description, and
wherein said gating circuit inserting section determines a kind of said gating circuit based on a call count of said function for transition of the input data.

3. The operation synthesis system according to claim 1, wherein an enable signal is supplied to said gating circuit,
wherein said gating circuit inserting section sets said enable signal such that said enable signal is activated only when said operating unit needs the input data and is deactivated when said operating unit does not need the input data, and
wherein said gating circuit transmits the input data from said input terminal to said operating unit when said enable signal is activated, and blocks off the transmission of the input data from said input terminal to said operating unit when said enable signal is deactivated.

4. The operation synthesis system according to claim 3, wherein said gating circuit is either of a latch-type circuit or an and-type circuit,
wherein said latch-type circuit holds its output to said operating unit at a time which said enable signal is deactivated, when said enable signal is deactivated, and
wherein said and-type circuit fixes its output to said operating unit on a predetermined value, when said enable signal is deactivated.

5. The operation synthesis system according to claim 4, wherein said operation is shown as a function in the operation description,
wherein said gating circuit inserting section compares a call count of said function for transition of the input data with a predetermined threshold value, and
said gating circuit inserting section selects said latch-type circuit as said gating circuit when the call count is equal to or more than the threshold value, and selects said and-type circuit as said gating circuit when the call count is less than the threshold value.

6. An operation synthesis method comprising:
performing operation synthesis of an operation description to generate a data path graph corresponding to the operation description, wherein said data path graph contains an input terminal configured to input an input data and an operating unit configured to perform an operation on the input data; and
inserting a gating circuit between said input terminal and said operating unit,
wherein said gating circuit blocks off transmission of the input data from said input terminal to said operating unit when said operating unit does not need the input data, and transmits the input data from said input terminal to said operating unit only when said operating unit needs the input data.

7. The operation synthesis method according to claim 6, wherein said operation is shown as a function in the operation description, and
wherein said inserting comprises:
determining a kind of said gating circuit based on a call count of said function for transition of the input data.

8. The operation synthesis method according to claim 6, further comprising:
setting an enable signal such that said enable signal is activated only when said operating unit needs the input data and is deactivated when said operating unit does not need the input data,
wherein said enable signal is supplied to said gating circuit, and
wherein said gating circuit transmits the input data from said input terminal to said operating unit when said enable signal is activated, and blocks off the transmission of the input data from said input terminal to said operating unit when said enable signal is deactivated.

9. The operation synthesis method according to claim 8, wherein said gating circuit is either of a latch-type circuit or an and-type circuit,
wherein said latch-type circuit holds its output to said operating unit at a time which said enable signal is deactivated, when said enable signal is deactivated, and
wherein said and-type circuit fixes its output to said operating unit on a predetermined value, when said enable signal is deactivated.

10. The operation synthesis method according to claim 9, wherein said operation is shown as a function in the operation description,
wherein said inserting comprises:
comparing a call count of said function for transition of the input data with a predetermined threshold value;
selecting said latch-type circuit as said gating circuit when the call count is equal to or more than the threshold value; and
selecting said and-type circuit as said gating circuit when the call count is less than the threshold value.

11. A computer-readable recording medium in which a program code is stored to realize an operation synthesis method, which comprises:
performing operation synthesis of an operation description to generate a data path graph corresponding to the operation description, wherein said data path graph contains an input terminal configured to input an input data and an operating unit configured to perform an operation on the input data; and
inserting a gating circuit between said input terminal and said operating unit,
wherein said gating circuit blocks off transmission of the input data from said input terminal to said operating unit when said operating unit does not need the input data, and transmits the input data from said input terminal to said operating unit only when said operating unit needs the input data.

12. The computer-readable recording medium according to claim 11, wherein said operation is shown as a function in the operation description, and
wherein said inserting comprises:
determining a kind of said gating circuit based on a call count of said function for transition of the input data.

13. The computer-readable recording medium according to claim 11, wherein said operation synthesis method further comprises:
setting an enable signal such that said enable signal is activated only when said operating unit needs the input data and is deactivated when said operating unit does not need the input data,
wherein said enable signal is supplied to said gating circuit, and
wherein said gating circuit transmits the input data from said input terminal to said operating unit when said enable signal is activated, and blocks off the transmission of the input data from said input terminal to said operating unit when said enable signal is deactivated.

14. The computer-readable recording medium according to claim 13, wherein said gating circuit is either of a latch-type circuit or an and-type circuit,
wherein said latch-type circuit holds its output to said operating unit at a time which said enable signal is deactivated, when said enable signal is deactivated, and
wherein said and-type circuit fixes its output to said operating unit on a predetermined value, when said enable signal is deactivated.

15. The computer-readable recording medium according to claim 14, wherein said operation is shown as a function in the operation description,
wherein said inserting comprises:
comparing a call count of said function for transition of the input data with a predetermined threshold value;
selecting said latch-type circuit as said gating circuit when the call count is equal to or more than the threshold value; and
selecting said and-type circuit as said gating circuit when the call count is less than the threshold value.
